(19) United States
(12) Patent Application Publication
(10) Pub. No.: US 2009/0206255 A1
(43) Pub. Date: Aug. 20, 2009

(54) SUBSTRATE INSPECTION DEVICE AND SUBSTRATE INSPECTION METHOD

(75) Inventors: Misako Saito, Yamanashi (JP); Teruyuki Hayashi, Yamanashi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Tokyo Electron Limited, Minato-ku, TOKYO (JP)

(21) Appl. No.: 12/279,617

(22) PCT Filed: Jan. 25, 2007
(86) PCT No.: PCT/JP2007/051178

§ 371 Date: Aug. 15, 2008

(30) Foreign Application Priority Data
Feb. 15, 2006 (JP) 2006-038521

(51) Int. Cl. G01N 23/00

(52) U.S. Cl. 250/310

(57) ABSTRACT

Provided is a substrate inspection apparatus for inspecting defects of a pattern formed on a laminated structure on a substrate. The laminated structure includes a first and a second layer sequentially formed on the substrate, which have different compositions from each other. The substrate inspection apparatus includes: an electron emission unit for irradiating primary electrons onto the substrate; an electron detection unit for detecting secondary electrons generated by irradiating the primary electrons; a data processing unit for processing data of the secondary electrons detected by the electron detection unit; and a voltage control unit for controlling an acceleration voltage of the primary electrons. The voltage control unit controls the acceleration voltage such that the primary electrons irradiated to the exposed second layer arrive at the inside of the first layer or the second layer other than near an interface of the first layer and the second layer.

### FIELD OF THE INVENTION

The present invention relates to a substrate inspection method of inspecting a pattern formed on a substrate and a substrate inspection apparatus for performing the inspection method.

### BACKGROUND OF THE INVENTION

There have been proposed various inspection methods for inspecting a pattern formed on a substrate in a fabrication process of semiconductor devices.

For example, there has been proposed a so-called electron beam inspection that detects defects of a pattern formed on a substrate by radiating an electron beam to the pattern to detect secondary electrons. The electron beam inspection is able to detect finer defects compared with an optical inspection and it is, therefore, used in detecting defects of patterns of semiconductor devices miniaturized recently.

However, in the electron beam inspection, there occurs a phenomenon wherein others than actual defects are detected, which is called an analogous defect detection. In particular, in case of detecting defects of a pattern formed on a laminated structure including laminated layers of different compositions, the analogous defect detection occurs, which deteriorates the accuracy of defect detection.

### Patent Document 1: Japanese Patent Laid-open Publication No. 2002-216698

### SUMMARY OF THE INVENTION

It is, therefore, an object of the present invention to provide a novel and useful substrate inspection apparatus and method.

Specifically, the present invention provides a substrate inspection apparatus and method capable of detecting defects of a pattern on a laminated structure on a substrate with high accuracy.

In accordance with a first aspect of the present invention, there is provided a substrate inspection apparatus for inspecting defects of a pattern formed on a laminated structure on a substrate, the laminated structure including a first and a second layer sequentially formed on the substrate, the first and the second layer having different compositions from each other and the pattern being formed such that the second layer is partially exposed, the apparatus including: an electron emission unit for irradiating primary electrons onto the substrate; an electron detection unit for detecting secondary electrons generated by irradiating the primary electrons; a data processing unit for processing data of the secondary electrons detected by the electron detection unit; and a voltage control unit for controlling an acceleration voltage such that the primary electrons irradiated to the exposed second layer arrive at the inside of the first layer or the second layer other than near an interface of the first layer and the second layer.

In accordance with a second aspect of the present invention, there is provided a substrate inspection method of inspecting defects of a pattern formed on a laminated structure on a substrate, the laminated structure including a first and a second layer sequentially formed on the substrate, the first and the second layer having different compositions from each other and the pattern being formed such that the second layer is partially exposed, the method including: an electron emission step of irradiating primary electrons to the substrate; an electron detection step of detecting secondary electrons generated by irradiating the primary electrons; and a data processing step of processing data of the secondary electrons detected in the electron detection step; wherein, in the electron emission step, an acceleration voltage is controlled in such a manner that the primary electrons irradiated to the exposed second layer arrive at the inside of the first layer or the second layer other than near an interface of the first layer and the second layer.

In accordance with the present invention, it is possible to provide a substrate inspection apparatus and method capable of detecting defects of a pattern on a laminated structure on a substrate with high accuracy.

### BRIEF DESCRIPTION OF THE DRAWINGS

FIGS. 1A to 1D are views illustrating a method of fabricating a semiconductor device.

FIGS. 2A to 2C are views visualizing defects of a pattern.

FIG. 3 is a view illustrating the relationship between an acceleration voltage and the number of analogous defects detected;

FIG. 4A is a view illustrating morphology of polysilicon.

FIG. 4B is a view illustrating defects generated on polysilicon of FIG. 4A.

FIG. 5A is a view showing morphology of polysilicon.

FIG. 5B is a view illustrating defects generated on polysilicon of FIG. 5A.

FIGS. 6A and 6B are views diagrammatically illustrating the principle of defect detection.

FIG. 7 is a view illustrating the range of primary electrons, which is obtained by a simulation.

FIG. 8 is a view diagrammatically illustrating a substrate inspection apparatus in accordance with an embodiment of the present invention.

FIG. 9 is a view illustrating input parameters.

FIG. 10 is a view illustrating a substrate inspection method in accordance with an embodiment of the present invention.

### DESCRIPTIONS OF REFERENCE NUMERALS

| | |
|---|---|
| 1: | substrate |
| 2: | gate insulating film |
| 3: | gate electrode layer |
| 3A: | gate electrode |
| 4: | bottom anti-reflective coating |
| 5: | photoresist layer |
| 5A: | resist pattern |
| 100: | substrate inspection apparatus |
| 101: | vacuum chamber |
| 102: | electron emission unit |
| 103: | collecting lens |
| 104: | scan coil |
| 105: | substrate support |
| 105A: | substrate |
| 106: | electron detection unit |
| 107: | power supply |
| 108: | computer |
| 109: | input unit |
| 110: | display unit |
| 111: | voltage detection unit |
| 112: | voltage control unit |
| 113: | data processing unit |

### DETAILED DESCRIPTION OF THE EMBODIMENTS

In accordance with a substrate inspection apparatus (a substrate inspection method) of the present invention, it is possible to detect defects of a pattern formed on a laminated structure on a substrate with high accuracy by means of an electron beam inspection. For example, the present inventors have found that it is difficult to inspect a pattern formed on a multi-layer structure having different compositions by using the electron beam inspection. There will now be described problems in the electron beam inspection and solutions thereof, which have been found by the present inventors.

For example, is case of inspecting a resist pattern formed on a film to be etched, it is difficult to inspect the resist pattern by means of the electron beam inspection. A bottom anti-reflective coating (BARC) usually remains under the resist pattern right after exposure/development of the resist pattern. That is, the resist pattern is formed on a laminated structure of the film to be etched and the BARC. Hereinafter, there will be described an example of fabricating a semiconductor device, including a process of forming the resist pattern. Parts described previously are assigned the same reference numerals, and redundant descriptions thereof will be omitted.

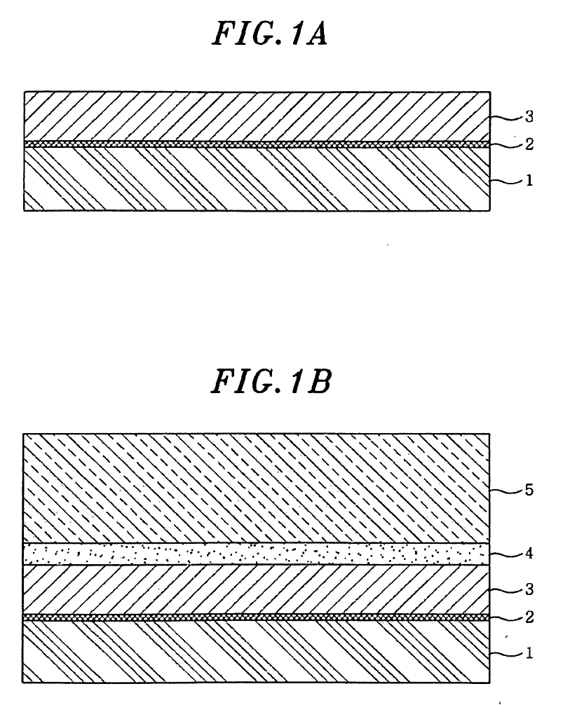

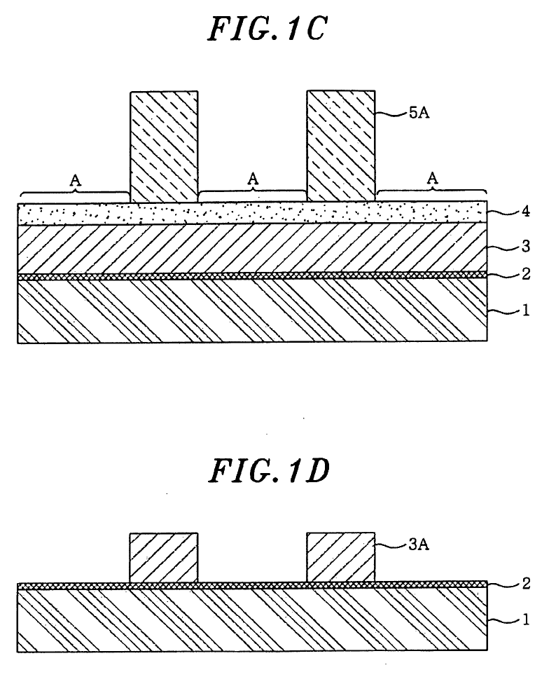

In a process shown in FIG. 1A, a gate insulating film 2 is formed on a substrate 1 formed from silicon. A gate electrode layer (first layer) 3 formed from polysilicon is formed on the gate insulating film 2.

In a process shown in FIG. 1B, a BARC (second layer) 4 is formed on the gate electrode layer 3. A photoresist layer 5 is formed on the BARC film 4.

In a process shown in FIG. 1C, exposure/development is performed on the photoresist layer 5 by using a so-called photolithography method to form a resist pattern 5A. The BARC 4 is exposed in regions A from which the resist layer 5 has been removed.

In a process shown in FIG. 1D, the BARC 4 and the gate electrode layer 3 are etched by using the resist pattern 5A, formed in FIG. 1C, as a mask. Consequently, the gate electrode layer 3 is patterned to form gate electrodes 3A.

Subsequently, a MOS transistor can be formed through a known method including etching of the gate insulating film 2, implantation and diffusion of an impurity and the like.

In the event that the transistor is formed, for example, it is preferred to detect patterning defects of the resist pattern 5A after the process of FIG. 1C. Conventionally, however, an inspection has usually been performed, for example, after etching using the resist pattern 5A as a mask (after the process of FIG. 1D).

Meanwhile, etching defects are frequently caused by defects in forming a pattern of a resist. If patterning defects can be detected at the time when the pattern of the resist is formed, the patterning defects can be detected more efficiently.

However, it has been found that it is difficult to inspect the resist pattern 5A formed on the laminated structure of the gate electrode layer 3 and the BARC 4 having different compositions, as shown in FIG. 1C, by using the electron beam inspection due to a problem of analogous defect detection. The present inventors have also found that the problem of analogous defect detection depends on an acceleration voltage of primary electrons in the electron beam inspection. This will now be described.

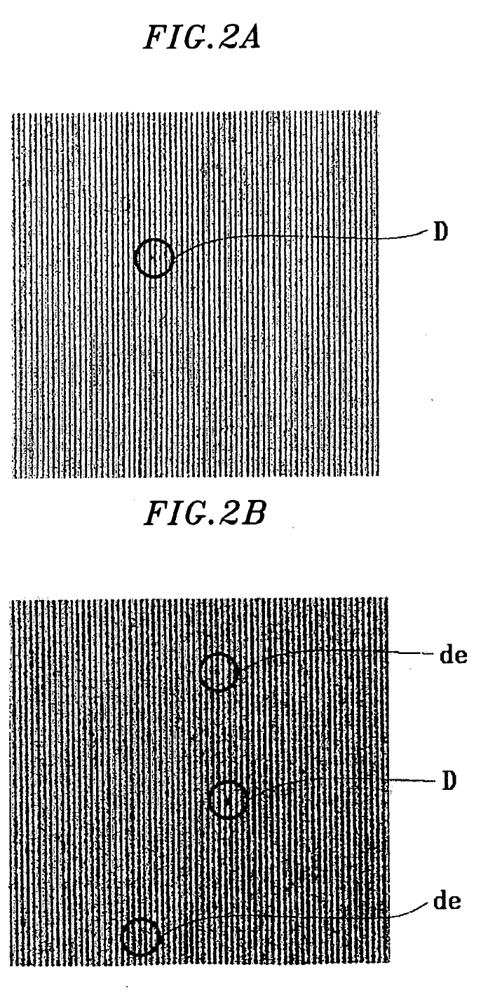

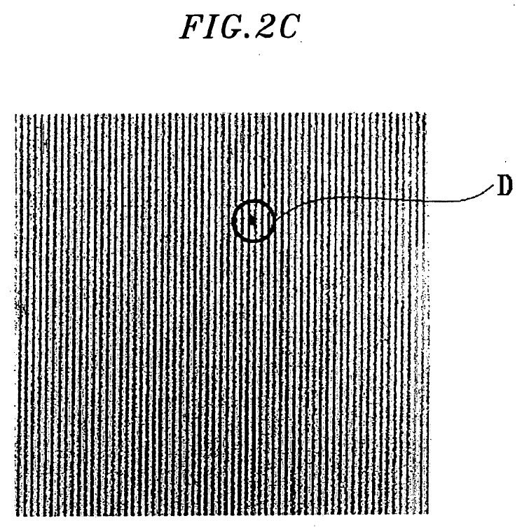

FIGS. 2A to 2C illustrate photographs (SEM photographs) by the electron beam inspection of the resist pattern in the structure shown in FIG. 1C. In FIGS. 2A to 2C, acceleration voltages of primary electrons are 300 eV, 1000 eV and 1500 eV, respectively.

Referring to FIGS. 2A to 2C, in each case, a defect D of the resist pattern (a portion where the resist pattern was fallen off) could be seen. Meanwhile, however, only in the case where the acceleration voltage was set to 1000 eV as shown in FIG. 2B, a plurality of analogous defects de appeared at portions where the BARC is exposed between the resist patterns. It was confirmed by an additional electrical characteristic inspection that the analogous defects de are analogous defects caused by problems of the electron beam inspection (electron beam inspection apparatus).

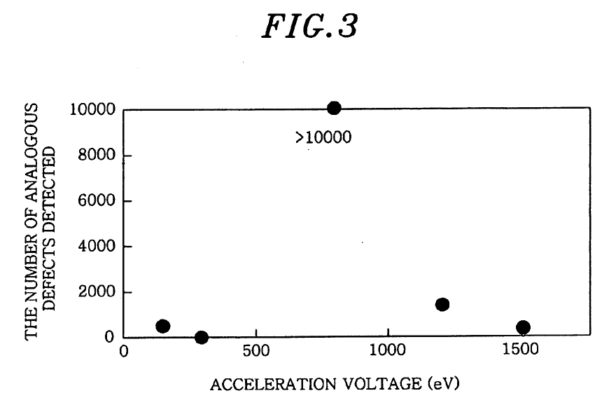

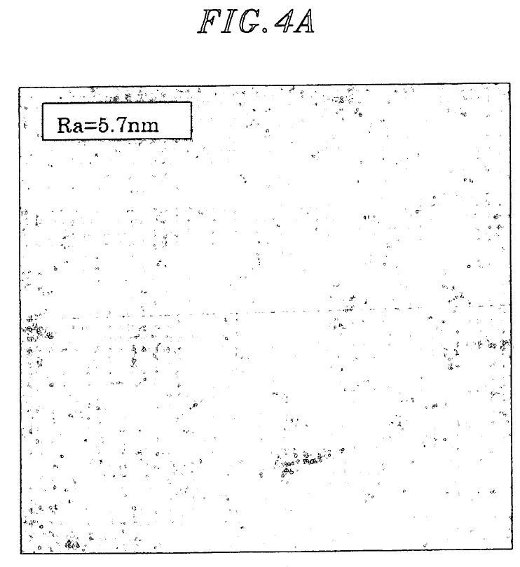

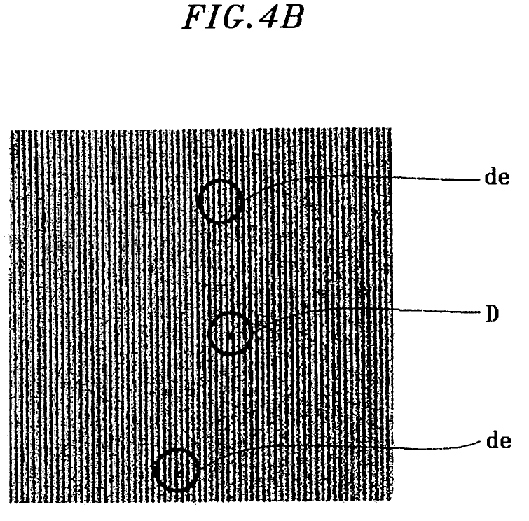

FIG. 3 is a view illustrating the relationship between an acceleration voltage and the number of analogous defects detected. Referring to FIG. 3, in the correlation between the acceleration voltage and the number of analogous defects detected, it can be seen that, in particular, the number of analogous defects significantly increases in a specified acceleration voltage range (e.g., about 800 to 1000 eV). In other words, the number of analogous defects detected becomes small in case the acceleration voltage is lower or higher than the specified acceleration voltage range.

It has been found that the increased number of analogous defects detected in the specified acceleration voltage range as described above is due to the influence of a layer underlying the pattern to be inspected through the following verification.

FIG. 4A is a SEM photograph showing a surface morphology of polysilicon, and FIG. 4B is a SEM photograph of a state where the BARC and the resist pattern are formed on polysilicon of FIG. 4A (the state shown in FIG. 1C).

Referring to FIG. 4A, it was found that the surface morphology of polysilicon had irregularity in grain shape. The surface roughness Ra of polysilicon was 5.7 nm.

Referring to FIG. 4B, it was found that analogous defects de occurred in the BARC between the resist patterns as described above. It was considered that the analogous defects were related to the surface morphology of the underlying polysilicon.

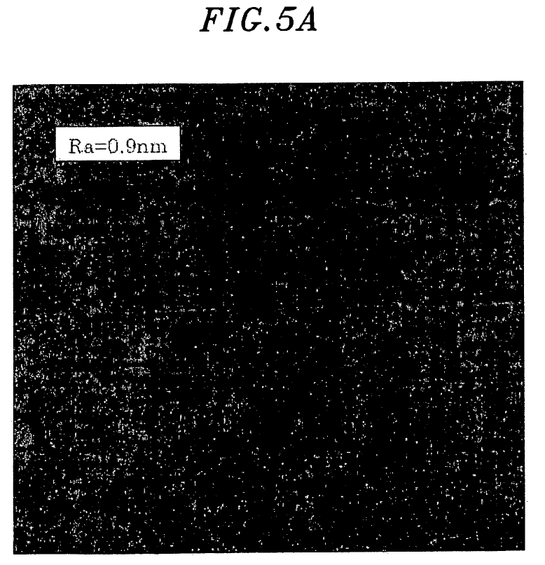

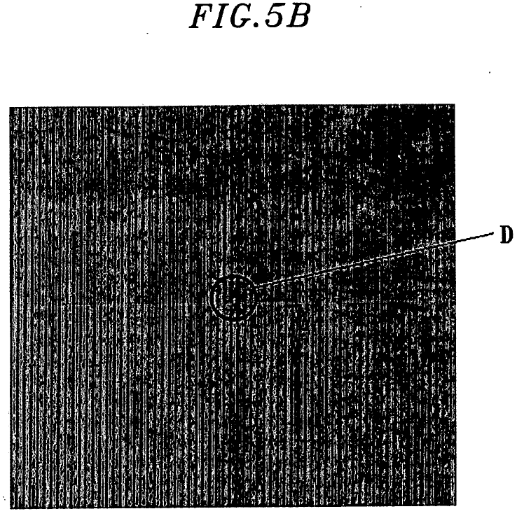

Thus, the electron beam inspection was performed on the same pattern formed on a polysilicon having a different surface morphology. FIG. 5A is a SEM photograph showing the surface morphology of polysilicon having a surface roughness different from that shown in FIG. 4A, and FIG. 5B is a SEM photograph of a state where the BARC and the resist pattern are formed on the polysilicon of FIG. 5A (the state shown in FIG. 1C).

Referring to FIG. 5A, the surface morphology of polysilicon had a smaller irregularity in grain shape than in the case of FIG. 4A. The surface roughness Ra of polysilicon was 0.9 nm.

Referring to FIG. 5B, in this case, analogous defects de as shown in FIG. 4A are rarely found. Accordingly, it becomes clear that the surface morphology of the underlying polysilicon contributes to analogous defects, which could be seen in FIG. 4B.

In view of the above results, the reason why the number of analogous defects detected increases significantly in the specified acceleration voltage range by means of the electron beam inspection will be described by using the following model.

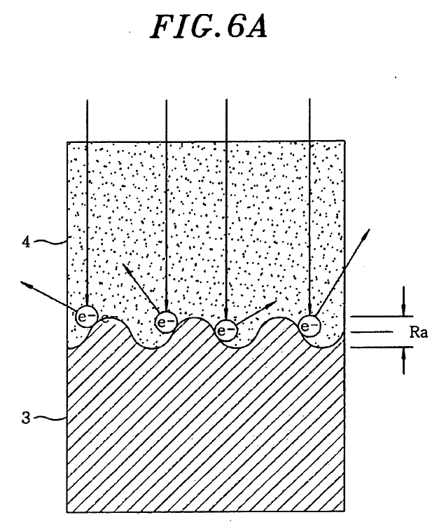

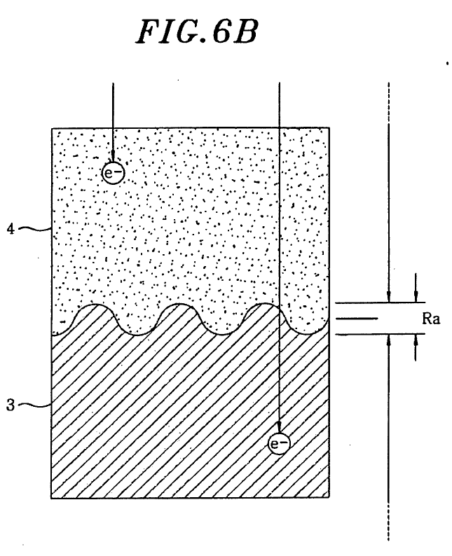

FIGS. 6A and 6B are views diagrammatically illustrating the behavior of primary electrons incident on the exposed BARC 4 (the regions A of FIG. 1C) in the electron beam inspection of the structure shown in FIG. 1C. In the drawings, parts described above are assigned the same reference numerals and redundant descriptions thereof will be omitted. Further, FIG. 6A illustrates a case where a large number of analogous defects are detected (for example, when the acceleration voltage is about 800 to 1000 eV in the above example), and FIG. 6B illustrates a case where a small number of analogous defects are detected (when the acceleration voltage is lower or higher than the specified range).

Referring to FIG. 6A, in this case, most of the primary electrons arrive near the interface of the gate electrode layer (first layer) 3 and the BARC (second layer) 4. As a result, it is believed that a lot of the primary electrons are reflected by the first layer.

In other words, in the event that defects of a pattern are detected by detecting secondary electrons, it is considered that the defects are influenced by the primary electrons reflected from the interface and are then detected as analogous defects. This phenomenon is considered to occur particularly when the first layer and the second layer have different compositions. It may be considered that this phenomenon is likely to happen when a difference in density between the first layer and the second layer is great.

For example, in the structure shown in FIG. 1C, the first layer is a layer of an inorganic material formed of polysilicon (an inorganic layer), and the second layer is a layer of an organic material formed of the BARC (an organic layer). For this reason, it is believed that this phenomenon is likely to occur because the density of the second layer is very smaller than that of the first layer and electrons are likely to penetrate the second layer.

Meanwhile, as shown in FIG. 6B, if the acceleration voltage of the primary electrons is lower or higher than a specified value, the primary electrons, which are reflected near the interface of the first layer and the second layer, have a less influence on detection of the secondary electrons.

In other words, since the range of the primary electrons depends on the acceleration voltage, it is preferable to control the acceleration voltage such that the number of analogous defects detected decreases. In this case, the acceleration voltage may be controlled in such a way that the primary electrons radiated to the exposed second layer (the regions A) arrive at the inside of the first layer or the second layer other than near the interface of the first layer and the second layer. Since the number of analogous defects detected reduces, defects of a pattern can be detected with high accuracy.

Here, “near interface” refers to a region in which the primary electrons are influenced by the surface morphology of the first layer. It may be considered that the near interface has a thickness corresponding to at least the surface roughness Ra with a centerline of the surface morphology of the first layer centered.

Further, in this case, the lowest limit of the acceleration voltage is preferably set so that at least the primary electrons can infiltrate into the first layer. The upper limit of the acceleration voltage is preferably set so that the primary electrons do not pass through the second layer. These can be easily calculated by using a Monte Carlo simulation.

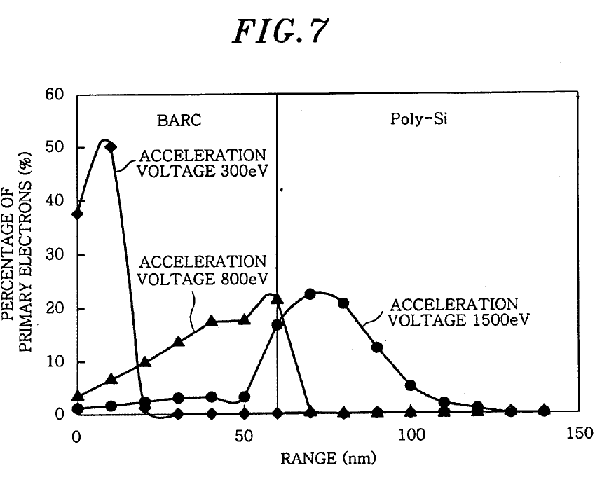

FIG. 7 is a view illustrating the result of finding ranges of the primary electrons in the regions A of FIG. 1C and the percentage of electrons existing at the ranges by using the simulation.

Referring to FIG. 7, for example, when the acceleration voltage was 800 eV, it was found that the primary electrons existed near the interface of the first layer and the second layer in large quantities. Meanwhile, when the acceleration voltage was 300 eV, it was found that most of the primary electrons reached only up to a shallow portion in the second layer (the BARC, indicated by “BARC” in the drawing) other than near the interface. Further, when the acceleration voltage was 1500 eV, it was found that most of the primary electrons reached the first layer (polysilicon).

The simulation result of FIG. 7 is well coincident with the results shown in FIGS. 2A to 2C and 3 and the model of analogous defect detection of FIGS. 6A and 6B.

If the range of the primary electrons is calculated by the simulation as described above, an acceleration voltage for allowing the primary electrons to reach the inside of the first layer or the second layer other than near the interface of the first layer and the second layer can be found easily.

Hereinafter, there will be described a substrate inspection apparatus employing the above principle and a substrate inspection method performed by using the substrate inspection apparatus.

### Embodiment 1

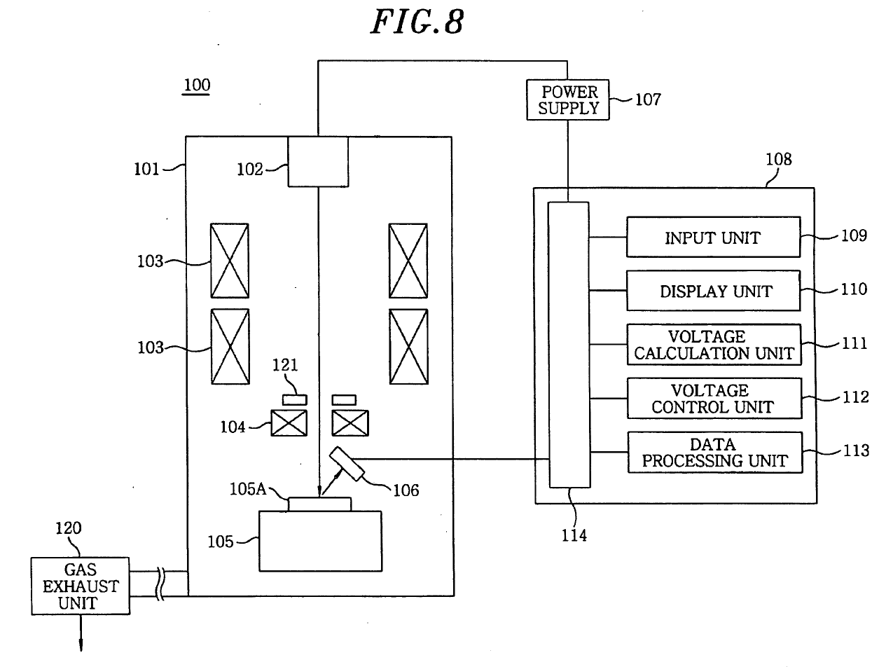

FIG. 8 is an example of the substrate inspection apparatus employing the above principle, and diagrammatically shows a substrate inspection apparatus 100.

Referring to FIG. 8, the substrate inspection apparatus 100 in accordance with the present embodiment has a vacuum chamber 101 whose inside is vacuum-exhausted by a gas exhaust unit 120 to be a depressurized space. A substrate support 105 for supporting a substrate 105A (corresponding to the substrate 1 of FIG. 1C) to be inspected is disposed in the vacuum chamber 101. An electron emission unit 102 is disposed opposite to the substrate support 105 and serves to irradiate primary electrons to the substrate 105A.

Collecting lenses 103 for collecting primary electrons (electron beams), scan coils 104 for scanning primary electrons, and an aperture 121 are disposed between the electron emission unit 102 and the substrate support 105. An electron detection unit 106 for detecting secondary electrons generated by irradiating primary electrons is also disposed between the substrate support 105 and the scan coils 104.

A power supply 107 is connected to the electron emission unit 102 and serves to apply a voltage thereto. The power supply 107 is connected to a bus 114 of a controller (computer) 108 for controlling the operation of the substrate inspection apparatus. The electron detection unit 106 is also connected to the bus 114 of the controller 108.

The controller 108 includes an input unit 109 such as a keyboard or communication means, a display unit 110 such as a monitor screen, a voltage calculation unit 111 for calculating an acceleration voltage applied by the power supply 107, a voltage control unit 112 for controlling the power supply 107 and a data processing unit 113 for processing data of secondary electrons detected by the electron detection unit 106, all of which are connected to the bus 114.

The power supply 107 applies to the electron emission unit 102 a voltage calculated by using the Monte Carlo simulation by means of the voltage calculation unit 111. The voltage control unit 112 controls the power supply 107 in response to the voltage calculated by the voltage calculation unit, and thus controls an acceleration voltage of primary electrons.

Electrons emitted from the electron emission unit 102 are irradiated to the substrate 105 to be inspected. The substrate 105 has, for example, the structure shown in FIG. 1C. That is, a laminated structure is formed on the substrate 105 (the substrate 1). The laminated structure has the second layer (the BARC 4) laminated on the first layer (the gate electrode layer 3), the second layer having a different composition from that of the first layer. The pattern (the resist pattern 5A) is formed on the laminated structure so that the second layer is partially exposed (in the regions A). Secondary electrons generated by the irradiated primary electrons are detected by means of the electron detection unit 106, and are then detected (recognized) as defects of the pattern by means of the data processing unit 113.

The acceleration voltage of the irradiated primary electrons is controlled by means of the voltage control unit 112. At this time, the acceleration voltage is controlled such that the primary electrons irradiated to the exposed second layer (in the regions A of FIG. 1C) arrive at the inside of the first layer or the second layer other than near the interface of the first layer and the second layer (refer to FIG. 6B).

Consequently, the influence of analogous defect detection due to reflection of the primary electrons near the interface (refer to FIG. 6A) as described above can be suppressed, so that defects of the pattern (the resist pattern 5A of FIG. 1C) can be detected with high accuracy.

At this time, the acceleration voltage may be more preferably calculated by using the Monte Carlo simulation by means of the voltage calculation unit 111.

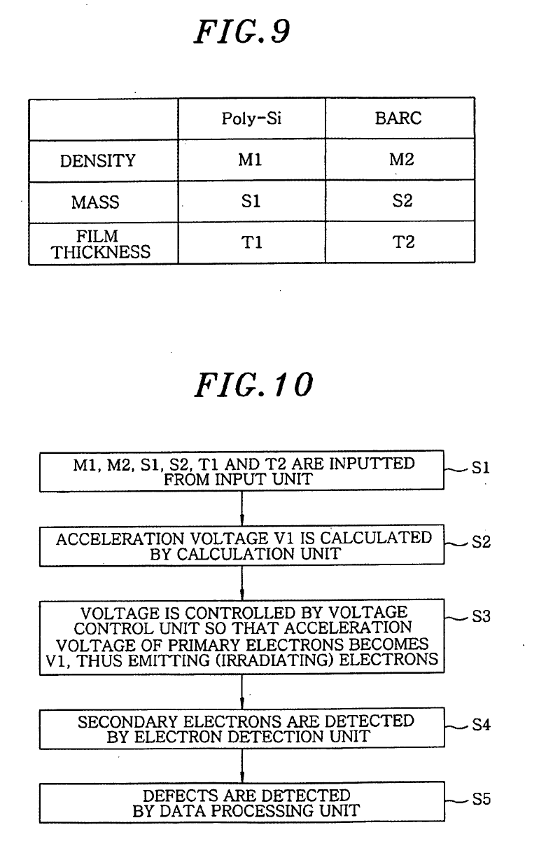

FIG. 9 is a view indicating parameters used in the Monte Carlo simulation. In the Monte Carlo simulation, an acceleration voltage for enabling the primary electrons to arrive at the inside of the first layer or the second layer other than near the interface is calculated based on density M1, mass S1 and film thickness T1 of the first layer (for example, polysilicon) and density M2, mass S2, and film thickness T2 of the second layer (for example, the BARC).

In the Monte Carlo simulation, by considering the behavior of primary electrons traveling while repeating elastic scattering and inelastic scattering, it is possible to obtain an acceleration voltage for enabling the primary electrons to reach a predetermined depth.

There will now be described an exemplary substrate inspection method performed by using the substrate inspection apparatus 100 shown in FIG. 8 by taking a case of inspecting the structure shown in FIG. 1C as an example with reference to the flowchart of FIG. 10. Parts described above are assigned the same reference numerals and redundant descriptions thereof will be omitted in the following description.

First, in step 1 (indicated by S1 in the drawing, the same is applied hereinafter), M1, M2, S1, S2, T1, and T2 are input from the input unit 109.

In step 2, an acceleration voltage V1 (eV) of primary electrons is calculated by means of the voltage calculation unit 111. The acceleration voltage V1 is calculated by using a simulation such that it becomes a value, which enables the primary electrons to arrive at the inside of the first layer or the second layer other than near the interface of the first layer (the gate electrode layer 3) and the second layer (the BARC 4).

In step 3, the power supply 107 is controlled by means of the voltage control unit 112 so that the acceleration voltage of the primary electrons emitted from the electron emission unit 102 becomes V1, and the primary electrons are emitted to be irradiated onto the substrate. At this time, the primary electrons arrive at the inside of the first layer or the second layer other than near the interface of the first layer and the second layer, so that secondary electrons are generated.

In step 4, the secondary electrons generated due to the primary electrons are detected by the electron detection unit 106. Detection data of the secondary electrons detected by the electron detection unit 106 are processed by the data processing unit 113 and defects of the resist pattern 5A are detected with high accuracy. This is because an acceleration voltage is optimized as described above and the influence of analogous defect detection is suppressed accordingly.

Although the patterning of the gate electrode has been described as an example in the above embodiment, the substrate inspection apparatus and the substrate inspection method of the present invention are not limited thereto. For example, defects of fine patterns on other laminated structures with different compositions or densities than the aforementioned structure can also be detected efficiently. In addition, compared with a conventional optical inspection method, defects of finer patterns can be detected by means of the substrate inspection apparatus or the substrate inspection method of the present embodiment. For example, 40 nm defects of a resist pattern in a 65 nm generation of a half-pitch (hp) can be detected by means of the substrate inspection apparatus of the present embodiment.

While the invention has been shown and described with respect to the preferred embodiments, it will be understood by those skilled in the art that various changes and modifications may be made without departing from the scope of the invention as defined in the following claims.

### INDUSTRIAL APPLICABILITY

The present invention provides a substrate inspection apparatus and method capable of detecting defects of a pattern on a laminated structure on a substrate with high accuracy.

This International Application claims a priority based on Japanese Patent Application No. 2006-38521 filed on Feb. 15, 2006, the entire contents of which are incorporated herein by reference.

What is claimed is:

1. A substrate inspection apparatus for inspecting defects of a pattern formed on a laminated structure on a substrate, the laminated structure including a first and a second layer sequentially formed on the substrate, the first and the second layer having different compositions from each other and the pattern being formed such that the second layer is partially exposed, the apparatus comprising:
an electron emission unit for irradiating primary electrons onto the substrate;
an electron detection unit for detecting secondary electrons generated by irradiating the primary electrons;
a data processing unit for processing data of the secondary electrons detected by the electron detection unit; and
a voltage control unit for controlling an acceleration voltage such that the primary electrons irradiated to the exposed second layer arrive at the inside of the first layer or the second layer other than near an interface of the first layer and the second layer.

2. The substrate inspection apparatus of claim 1, further comprising a voltage calculation unit for calculating the acceleration voltage of the primary electrons by using a simulation.

3. The substrate inspection apparatus of claim 1, wherein the first layer is an inorganic layer, and the second layer is an organic layer.

4. The substrate inspection apparatus of claim 1, wherein a surface of the first layer has irregularity in grain shape.

5. The substrate inspection apparatus of claim 4, wherein the first layer is formed from polysilicon.

6. The substrate inspection apparatus of claim 1, wherein the second layer comprises a bottom anti-reflective coating (BARC), and the pattern is formed from a photoresist.

7. A substrate inspection method of inspecting defects of a pattern formed on a laminated structure on a substrate, the laminated structure including a first and a second layer sequentially formed on the substrate, the first and the second layer having different compositions from each other and the pattern being formed such that the second layer is partially exposed, the method comprising:
an electron emission step of irradiating primary electrons to the substrate;
an electron detection step of detecting secondary electrons generated by irradiating the primary electrons; and
a data processing step of processing data of the secondary electrons detected in the electron detection step;
wherein, in the electron emission step, an acceleration voltage is controlled in such a manner that the primary electrons irradiated to the exposed second layer arrive at the inside of the first layer or the second layer other than near an interface of the first layer and the second layer.

8. The substrate inspection method of claim 7, wherein the acceleration voltage of the primary electrons is calculated by using a simulation.

9. The substrate inspection method of claim 7, wherein the first layer is an inorganic layer, and the second layer is an organic layer.

10. The substrate inspection method of claim 7, wherein a surface of the first layer has irregularity in grain shape.

11. The substrate inspection method of claim 10, wherein the first layer is formed from polysilicon.

12. The substrate inspection method of claim 7, wherein the second layer comprises a BARC, and the pattern is formed from a photoresist.
